(19) United States
(12) Patent Application Publication
(10) Pub. No.: US 2026/0006574 A1
(43) Pub. Date: Jan. 1, 2026

(54) SIGNALING MECHANISMS FOR POSITIONING FOR USER EQUIPMENTS WITH REDUCED CAPABILITY

(71) Applicant: Intel Corporation, Santa Clara, CA (US)

(72) Inventors: Gang XIONG, Portland, OR (US); Debdeep CHATTERJEE, San Jose, CA (US); Guotong WANG, Beijing (CN); Seunghee HAN, San Jose, CA (US); Jihyun LEE, Santa Clara, CA (US)

(21) Appl. No.: 18/992,967

(22) PCT Filed: Aug. 10, 2023
(86) PCT No.: PCT/US2023/072011

§ 371 Date: Jan. 9, 2025

Related U.S. Application Data
(60) Provisional application No. 63/397,616, filed on Aug. 12, 2022.
(60) Provisional application No. 63/482,967, filed on Feb. 2, 2023.

(51) Int. Cl. H04W 64/00; H04L 5/00; H04W 76/20

(52) U.S. Cl. CPC H04W 64/00; H04L 5/0012; H04L 5/0051; H04W 76/20

(57) ABSTRACT

Various embodiments herein provide techniques for frequency hopping for positioning with reduced capability (RedCap) user equipments (UEs). For example, the RedCap UE may perform downlink positioning reference signal (DL-PRS) measurements using frequency hopping and bandwidth stitching. Additionally, or alternatively, the RedCap UE may transmit an uplink sounding reference signal (UL-SRS) using frequency hopping. Other embodiments may be described and claimed.

### CROSS REFERENCE TO RELATED APPLICATION

The present application claims priority to U.S. Provisional Patent Application No. 63/397,616, which was filed Aug. 12, 2022; and to U.S. Provisional Patent Application No. 63/482,967, which was filed Feb. 2, 2023.

### FIELD

Various embodiments generally may relate to the field of wireless communications. For example, some embodiments may relate to techniques for positioning measurements for user equipments (UEs) with reduced capability.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich content and services.

NR supports highly precise positioning in the vertical and horizontal dimensions, which relies on timing-based, angle-based, power-based or hybrid techniques to estimate the user location in the network. With wide bandwidth for positioning signal and beamforming capability in mmWave frequency band, higher positioning accuracy can be achieved by RAT-dependent positioning techniques. Note that in 3GPP Release (Rel)-16, downlink positioning reference signal (DL-PRS) and uplink sounding reference signal (UL-SRS) for positioning were introduced as enablers to achieve target performance characteristics.

It has been identified as beneficial to support a class of NR user equipments (UEs) with complexity and power consumption levels lower than 3GPP Rel-15 NR UEs, catering to use cases like industrial wireless sensor networks (IWSN), certain class of wearables, and video surveillance, to fill the gap between current low power wide area (LPWA) solutions and enhanced mobile broadband (eMBB) solutions in NR and also to further facilitate a smooth migration from 3.5G and 4G technologies to 5G (NR) technology for currently deployed bands serving relevant use cases requiring relatively low-to-moderate reference (e.g., median) and peak user throughputs, low device complexity, small device form factors, and relatively long battery lifetimes.

Towards the above, in 3GPP Rel-17, a class of Reduced Capability (RedCap) NR UEs was introduced using the currently specified 5G NR framework with necessary adaptations and enhancements to limit device complexity and power consumption while minimizing any adverse impact to network resource utilization, system spectral efficiency, and operation efficiency. In particular, RedCap UEs typically support a maximum UE bandwidth (BW) of 20 MHz in frequency range 1 (FR1) bands and a maximum UE BW of 100 MHz in frequency range 2 (FR2) bands.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of subband-based frequency hopping for downlink positioning reference signal (DL-PRS) measurement, in accordance with various embodiments.

FIG. 2 illustrates another example of subband-based frequency hopping for DL-PRS measurement, in accordance with various embodiments.

FIG. 3 illustrates an example of bandwidth part (BWP)-based frequency hopping for DL-PRS, in accordance with various embodiments.

FIG. 4 illustrates another example of BWP-based frequency hopping for DL-PRS, in accordance with various embodiments.

FIG. 5 illustrates an example of BWP-based frequency hopping for uplink (UL) sounding reference signal (SRS) for positioning, in accordance with various embodiments.

FIG. 6 illustrates another example of BWP-based frequency hopping for UL SRS for positioning, in accordance with various embodiments.

FIG. 7 illustrates an example of frequency hopping for reception of DL PRS for reduced capability (RedCap) user equipments (UEs), in accordance with various embodiments.

FIG. 8 illustrates an example of frequency hopping for SRS for positioning for RedCap UEs

FIG. 9 schematically illustrates a wireless network in accordance with various embodiments.

FIG. 10 schematically illustrates components of a wireless network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 12, 13, and 14 depict example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

As mentioned above, NR supports highly precise positioning in the vertical and horizontal dimensions, which relies on timing-based, angle-based, power-based or hybrid techniques to estimate the user location in the network. For example, the following RAT-dependent positioning techniques may be used, which can meet the positioning requirements for various use cases, e.g., indoor, outdoor, Industrial internet of thing (IoT), etc:
Downlink time difference of arrival (DL-TDOA);
Uplink time difference of arrival (UL-TDOA);
Downlink angle of departure (DL-AoD);
Uplink angle of arrival (UL AoA);
Multi-cell round trip time (multi-RTT);
NR enhanced cell ID (E-CID).

With wide bandwidth for positioning signal and beamforming capability in mmWave frequency band, higher positioning accuracy can be achieved by RAT dependent positioning techniques. Note that in Rel-16, downlink positioning reference signal (DL-PRS) and uplink sounding reference signal (UL-SRS) for positioning were introduced as enablers to achieve target performance characteristics.

For reduced capability (RedCap) user equipments (UEs), bandwidth limitation may lead to insufficient resolution in time domain and affect the accuracy of the DL-TDOA, UL-TDOA, and Multi-RTT timing based positioning methods. Various embodiments herein may provide techniques for frequency hopping for DL-PRS and/or UL-SRS to improve the positioning accuracy. In some embodiments, two consecutive frequency hops may share a number of overlapped physical resource blocks (PRBs). In this case, multiple channel observations obtained with frequency hopping measurements can be processed at the receiver side to “stitch” them into a wideband channel realization, which would result in a sample time duration reduction and discrete Fourier size extension. The number of overlapping PRBs across two frequency hops can enable a receiver to estimate the frequency offset between two hops and compensate for the same to realize coherent combining processing gains.

Various embodiments herein provide systems and methods for frequency hopping for positioning support of RedCap UEs. For example, aspects of various embodiments may include:
Frequency hopping with bandwidth stitching for DL-PRS transmission; and/or
Frequency hopping with bandwidth stitching for UL-SRS transmission for positioning;
Signaling mechanisms for DL-PRS transmission for RedCap UEs;
Signaling mechanisms for UL-SRS transmission for positioning for RedCap UEs.
   Frequency Hopping with Bandwidth Stitching for DL-PRS Transmission

Embodiments of frequency hopping with bandwidth stitching for DL-PRS transmission are described further below.

In one embodiment, wideband DL-PRS transmission may be configured to a RedCap UE for a DL-PRS resource such that the wideband DL-PRS transmission BW may exceed the maximum RedCap UE BW for the corresponding Frequency Range (FR). Further, for each DL-PRS transmission in the DL-PRS resource, multiple subbands for DL-PRS transmission in frequency can be configured by higher layers via radio resource control (RRC) signalling and the UE may be configured to perform frequency hopping across the configured multiple subbands. In some aspects, one or more subbands may overlap in frequency to allow coherent combining of the channel observations in multiple frequency hops at the receiver.

In one option, subband size and subband distance between two adjacent subbands in each DL-PRS transmission can be configured by higher layers via RRC signalling. In this case, UE determines a set of PRBs for positioning measurement in accordance with the subband size and subband distance in each DL-PRS repetition.

In another option, the subband size and number of overlapping PRBs between two subbands can be configured by higher layers via RRC signalling. In this case, UE determines a set of PRBs for positioning measurement in accordance with the subband size and number of overlapping PRBs between two subbands in each DL-PRS repetition.

In another example of the embodiment, a UE may not expect to be configured with a subband size in frequency dimension exceeding the maximum RedCap UE BW for the corresponding FR.

In another example of the embodiment, the repetitions of DL-PRS may be mapped in time domain such that one or more symbols or slots or a specified time gap (in absolute time units) are provisioned to accommodate any gaps necessary for a RedCap UE to retune from one subband to another. The symbols or slots may be defined using the numerology of the associated DL-PRS.

In another embodiment, a DL-PRS frequency hopping pattern may be pre-defined in the specification. In particular, the starting subband index for the frequency hopping can be configured by higher layers via RRC signalling. The subband index can be increased by 1 and modulo on total number of subbands for the subsequent DL-PRS repetition in a DL-PRS resource.

In this case, for i-th DL-PRS repetition, the starting PRB can be determined by

$${RB}_{start , i}^{DL - PRS} = {RB}_{start , 0}^{D L - PRS} + i \cdot {Δ}_{PRB}^{DL - PRS}$$

Where

$${RB}_{start , 0}^{DL - PRS}$$

is provided by dl-PRS-StartPRB and

$${Δ}_{PRB}^{DL - PRS}$$

is the subband distance between two adjacent subbands.

In another example of the embodiment, a UE may not expect to be configured with a subband size in frequency dimension exceeding the maximum RedCap UE BW for the corresponding FR.

In another example of the embodiment, the repetitions of DL-PRS may be mapped in time domain such that one or more symbols or slots are provisioned to accommodate any gaps necessary for a RedCap UE to retune from one subband to another. The symbols or slots may be defined using the numerology of the associated DL-PRS.

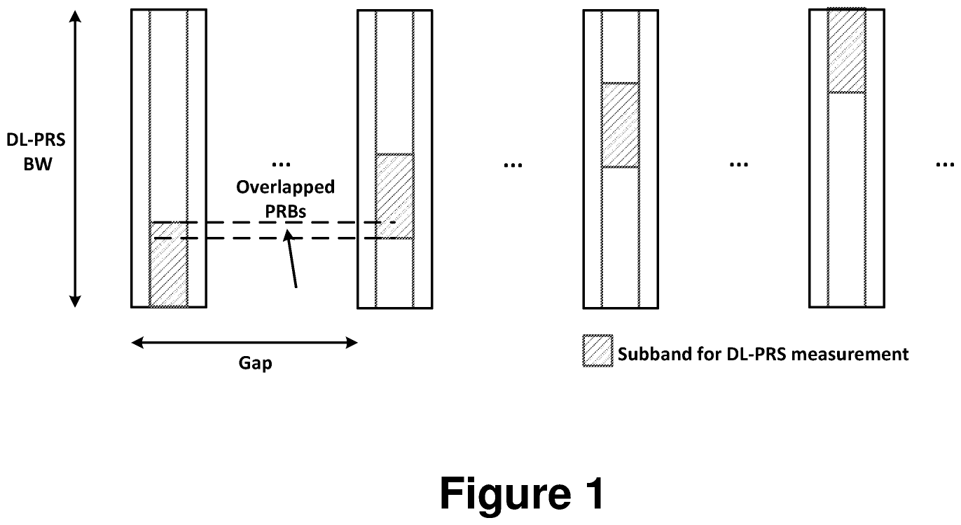

FIG. 1 illustrates one example of subband based frequency hopping for DL-PRS measurement. In the figure, 4 repetitions are configured for DL-PRS resource. In addition, UE performs subband based frequency hopping on the DL-PRS measurement. The subband index for each DL-PRS repetition is increased by 1. In some aspects, adjacent subbands overlap in frequency domain for bandwidth stitching.

In another embodiment, a DL-PRS frequency hopping pattern may be defined in accordance with one or more following parameters: starting PRB for the first repetition, the subband index and DL-PRS repetition index.

In another embodiment, UE performs subband frequency hopping for positioning measurement on a group of every K DL-PRS repetitions. In particular, within the group of every K DL-PRS repetitions, same set of PRBs are used for DL-PRS measurement. In some aspects, K can be predefined in the specification or configured by higher layers via RRC signalling.

In some aspects, two gaps between DL-PRS repetitions may be configured by higher layers, where the first gap may be configured between two repetitions within a group of every K DL-PRS repetitions; and the second gap may be configured between two groups of every K DL-PRS repetitions. In some aspects, the gaps may be defined in accordance with a number of symbols or slots or absolute time. In the latter case, it can be determined based on the number of slots and numerology for DL-PRS transmission.

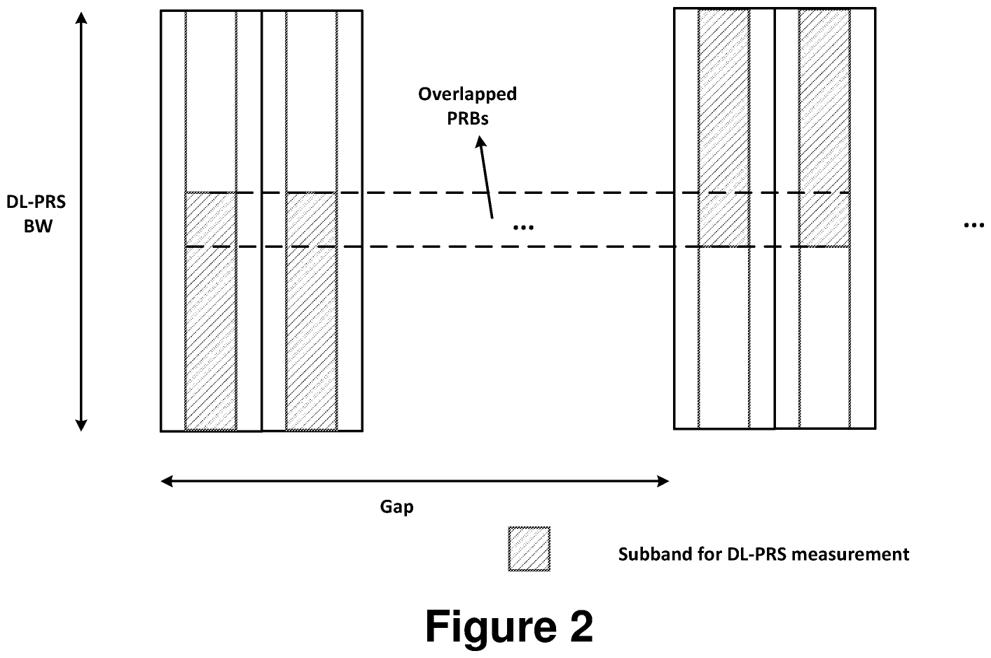

FIG. 2 illustrates one example of subband based frequency hopping for DL-PRS measurement. In the figure, 4 repetitions are configured for DL-PRS resource and K=2. In addition, UE performs subband based frequency hopping on every 2 repetitions for the DL-PRS measurement. Within 2 repetitions, same set of PRBs are used for DL-PRS measurement.

In another embodiment, DL-PRS repetitions for a DL-PRS resource may be transmitted in different DL bandwidth parts (BWPs) that may be configured to a RedCap UE for frequency hopping. Further, a gap may be configured between two DL-PRS repetitions for BWP switching.

In some aspects, the gaps may be defined in accordance with a number of symbols or slots or absolute time. In the latter case, it can be determined based on the number of slots and numerology for DL-PRS transmission.

For this option, starting PRB for DL-PRS transmission may be defined in accordance with the starting PRB of an BWP. In some aspects, one or more DL-PRS repetitions or DL BWP for DL-PRS transmission may overlap in frequency to allow coherent combining of the channel observations in multiple frequency hops at the receiver.

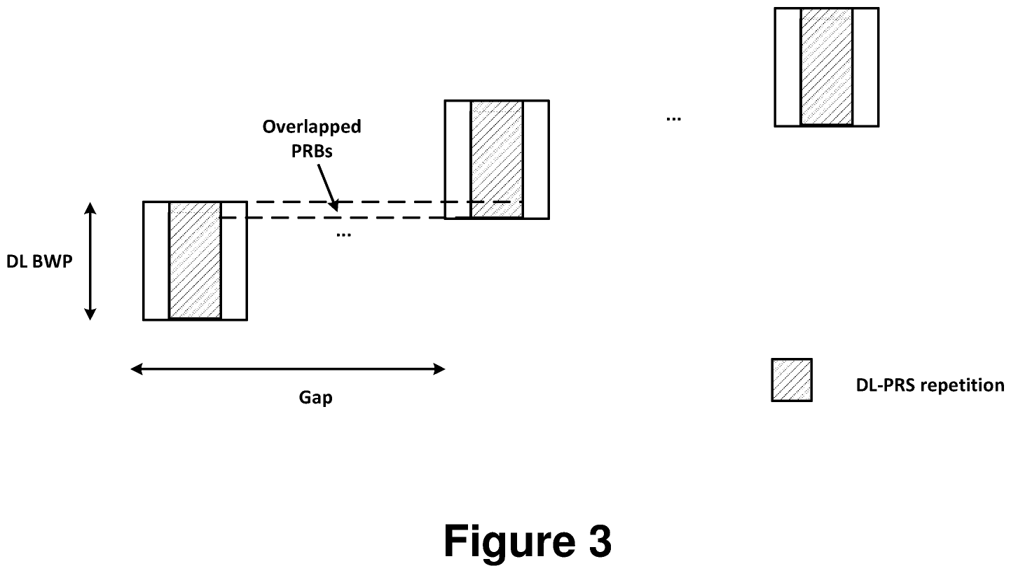

FIG. 3 illustrates one example of BWP based frequency hopping for DL-PRS. In the figure, DL-PRS fully occupies the DL BWP in frequency domain. Further, 3 repetitions are configured for DL-PRS transmission in a DL-PRS resource, where each DL-PRS repetition is transmitted in separate DL BWP.

In another embodiment, a group of every K DL-PRS repetitions for a DL-PRS resource may be transmitted in different DL BWPs configured to a RedCap UE for frequency hopping. In addition, same set of frequency resources may be used for DL-PRS repetitions within the group of every K DL-PRS repetitions. In some aspects, K can be predefined in the specification or configured by higher layers via RRC signalling.

Further, two gaps between DL-PRS repetitions may be configured by higher layers, where the first gap may be configured between two repetitions within a group of every K DL-PRS repetitions; and the second gap may be configured between two groups of every K DL-PRS repetitions. In some aspects, the gaps may be defined in accordance with a number of symbols or slots or absolute time. In the latter case, it can be determined based on the number of slots and numerology for DL-PRS transmission.

For this option, starting PRB for DL-PRS transmission may be defined in accordance with the starting PRB of an BWP.

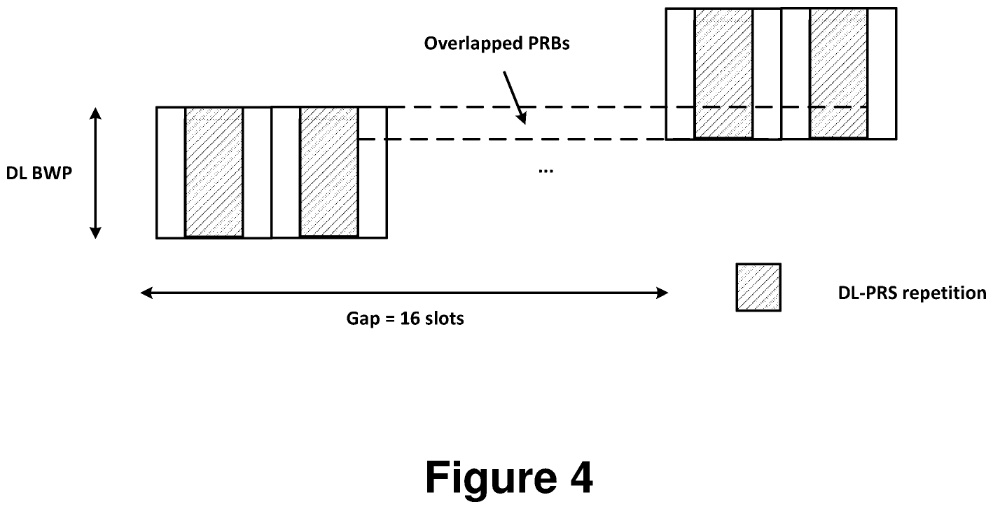

FIG. 4 illustrates one example of BWP based frequency hopping for DL-PRS. In the figure, DL-PRS fully occupies the DL BWP in frequency domain. Further, 4 repetitions are configured for DL-PRS transmission in a DL-PRS resource and K=2. The gap between every 2 repetitions is 1 slot while the gap between the set of every 2 repetitions are 16 slots.

In another embodiment, a RedCap UE may be configured with a DL-PRS configuration such that the DL-PRS are mapped to one of N subbands or N DL BWPs across r*N consecutive DL-PRS transmission occasions such that a pair of consecutive DL-PRS occasions may be separated by a time gap of a number of symbols or slots of absolute time, wherein r is an integer greater than or equal to one. Further, a set of r*N consecutive-in-time DL-PRS transmission occasions spanning the N subbands or DL BWPs may be configured to repeat K times.

In contrast to the embodiments above that use a “repeat (within a hop)-then-hop” approach, this embodiment utilizes a “hop-then-repeat” approach, with possibility of r≥1 repetitions within each hop. Such a design may enable a trade-off between combining gains from combining repetitions for a frequency hop against accurate estimation of the frequency offset between the DL-PRS reception across two consecutive frequency hops for coherent combining across different frequency hops.

Frequency Hopping with Bandwidth Stitching for UL-SRS Transmission for Positioning

Embodiments of frequency hopping with bandwidth stitching for UL-SRS transmission for described further below.

In one embodiment, UL SRS for positioning for a UL SRS resource are transmitted in different UL BWPs or UL subbands configured to a RedCap UE for frequency hopping. Further, a gap may be configured between two UL SRS transmissions for BWP switching. In some aspects, the gaps may be defined in accordance with a number of symbols or slots or absolute time. In the latter case, it can be determined based on the number of slots and numerology for UL SRS transmission.

In an example, the UL BWPs or UL subbands may be configured with the same numerology, BWP or subband size, and same shared and control channel configurations with exception of different starting PRBs.

In another example, the UL BWPs or UL subbands may be configured with the same numerology but may have different BWP or subband sizes, different shared and control channel configurations, and different starting PRBs.

For this option, starting PRB for UL SRS transmission may be defined in accordance with the starting PRB of an BWP or subband. In some aspects, one or more UL SRS repetitions or UL BWP or subband for UL SRS transmission may overlap in frequency to allow coherent combining of the channel observations in multiple frequency hops at the receiver.

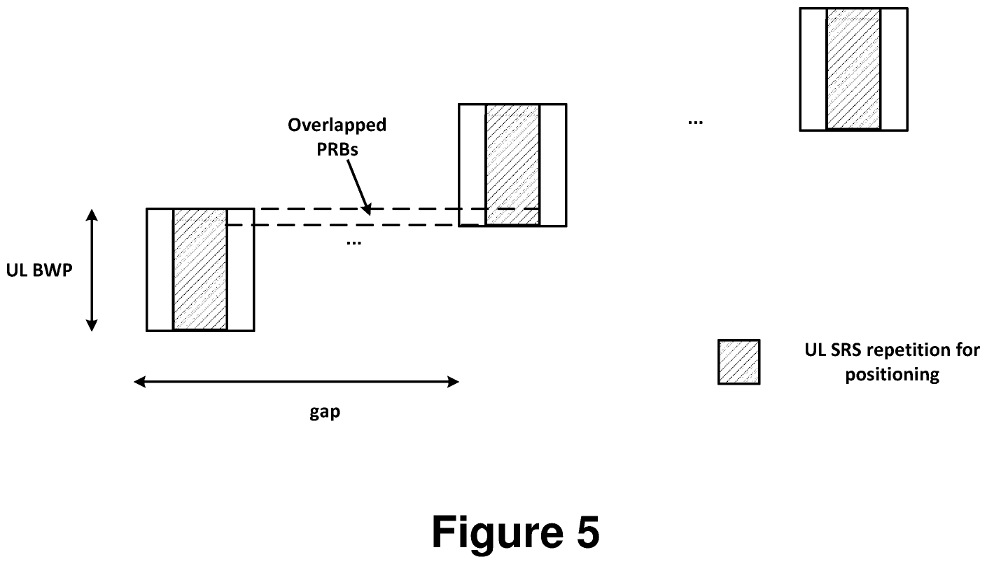

FIG. 5 illustrates one example of BWP based frequency hopping for UL SRS for positioning. In the figure, UL SRS for positioning fully occupies the UL BWP in frequency domain. Further, 3 repetitions are configured for UL SRS transmission in a SRS resource, where each SRS repetition is transmitted in separate UL BWP.

In another embodiment, a group of every K SRS repetitions for positioning for a SRS resource are transmitted in different UL BWP or subband for frequency hopping. In addition, same set of frequency resources are used for SRS repetitions within the group of every K SRS repetitions. In some aspects, K can be predefined in the specification or configured by higher layers via RRC signalling.

Further, two gaps between SRS repetitions may be configured by higher layers, where the first gap may be configured between two repetitions within a group of every K SRS repetitions; and the second gap may be configured between two groups of every K SRS repetitions. In some aspects, the gaps may be defined in accordance with a number of slots or absolute time. In the latter case, it can be determined based on the number of slots and numerology for SRS transmission.

For this option, starting PRB for SRS transmission may be defined in accordance with the starting PRB of an BWP or subband.

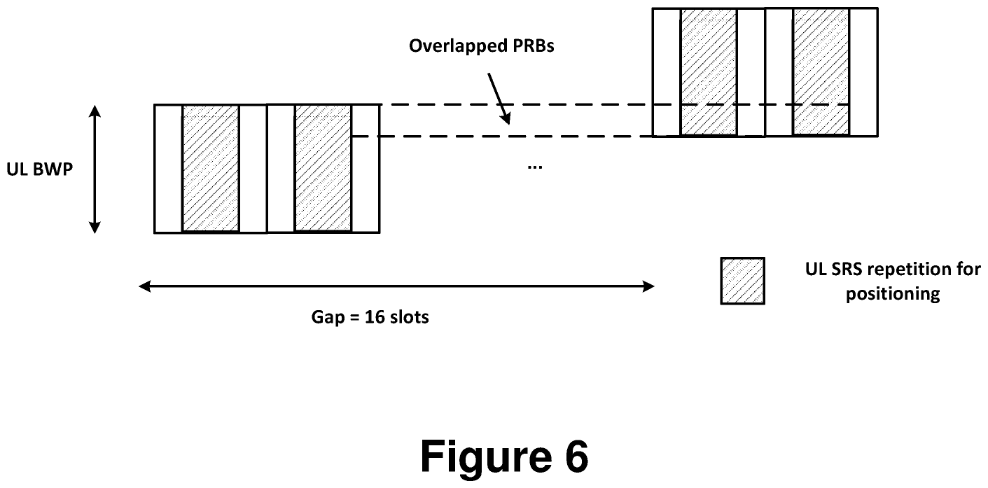

FIG. 6 illustrates one example of BWP based frequency hopping for SRS for positioning. In the figure, SRS for positioning fully occupies the UL BWP in frequency domain. Further, 4 repetitions are configured for SRS transmission in an SRS resource and K=2. The gap between every 2 repetitions is 1 slot while the gap between the set of every 2 repetitions are 16 slots.

In another embodiment, a RedCap UE may be configured with an SRS configuration such that the SRS are mapped to one of N UL BWPs or subbands across r*N consecutive SRS transmission occasions such that a pair of consecutive SRS occasions may be separated by a time gap of a number of symbols or slots of absolute time, wherein r is an integer greater than or equal to one. Further, a set of r*N consecutive-in-time SRS transmission occasions spanning the N UL BWPs or subbands may be configured to repeat K times.

In contrast to the embodiment above that use a “repeat (within hop)-then-hop” approach, this embodiment utilizes a “hop-then-repeat” approach, with possibility of r≥1 repetitions within each hop. Such a design may enable a trade-off between combining gains from combining repetitions for a frequency hop against accurate estimation of the frequency offset between the SRS reception across two consecutive frequency hops for coherent combining across different frequency hops at the gNB receiver.

### Signalling Mechanisms for DL-PRS Transmission for RedCap UEs

As mentioned above, bandwidth limitation may lead to insufficient resolution in time domain and affects the accuracy of the downlink time difference of arrival (DL-TDOA), uplink time difference of arrival (UL-TDOA), and multi-cell round trip time (multi-RTT) timing based positioning methods. To improve the positioning accuracy, frequency hopping with bandwidth stitching method can be considered for the transmission of DL-PRS and/or UL-SRS for positioning, wherein two consecutive frequency hops share a number of overlapped PRBs. In this case, multiple channel observations obtained with frequency hopping measurements can be processed at the receiver side to “stitch” them into a wideband channel realization, which would result in a sample time duration reduction and discrete Fourier size extension.

Embodiments of signalling mechanisms for DL-PRS transmission for RedCap UEs are described further below.

In one embodiment, DL PRS sequence is generated in accordance with the DL PRS positioning frequency layer configuration that may exceed the maximum supported bandwidth by a RedCap UE. Further, DL PRS sequence may be mapped to the time-frequency resources allocated for DL PRS transmission in accordance with DL PRS positioning frequency layer configuration. In another option, DL PRS sequence may be mapped to the time-frequency resources in accordance with the frequency hopping pattern provided to a RedCap UE.

In another embodiment, DL PRS sequence may be mapped to the time-frequency resources allocated for DL PRS transmission in accordance with DL PRS positioning frequency layer configuration, however, a RedCap UE may assume that a DL PRS sequence is transmitted in the time-frequency resources confined to a frequency subband in accordance with a frequency hopping pattern provided to a RedCap UE. In this case, the assumption on DL PRS transmission by a RedCap UE can be decoupled from the actual transmission of DL PRS as long as DL PRS transmission includes the frequency subbands as per the frequency hopping pattern indicated to a RedCap UE. This allows a gNB to transparently choose between the option of transmitting a single common DL PRS that may be received by RedCap and non-RedCap UEs and the option of transmitting DL PRS for RedCap UEs separate from that for non-RedCap UEs.

In some aspects, multiple subbands for DL-PRS transmission in frequency can be configured by higher layers via radio resource control (RRC) signalling and the UE may be configured to perform frequency hopping across the configured multiple subbands.

In some aspects, one or more subbands may overlap in frequency to allow coherent combining of the channel observations in multiple frequency hops at the receiver. Further, subband size and subband distance between two adjacent subbands in each DL-PRS repetition can be configured by higher layers via RRC signalling. In this case, UE determines a set of PRBs for positioning measurement in accordance with the subband size and subband distance in each DL-PRS repetition.

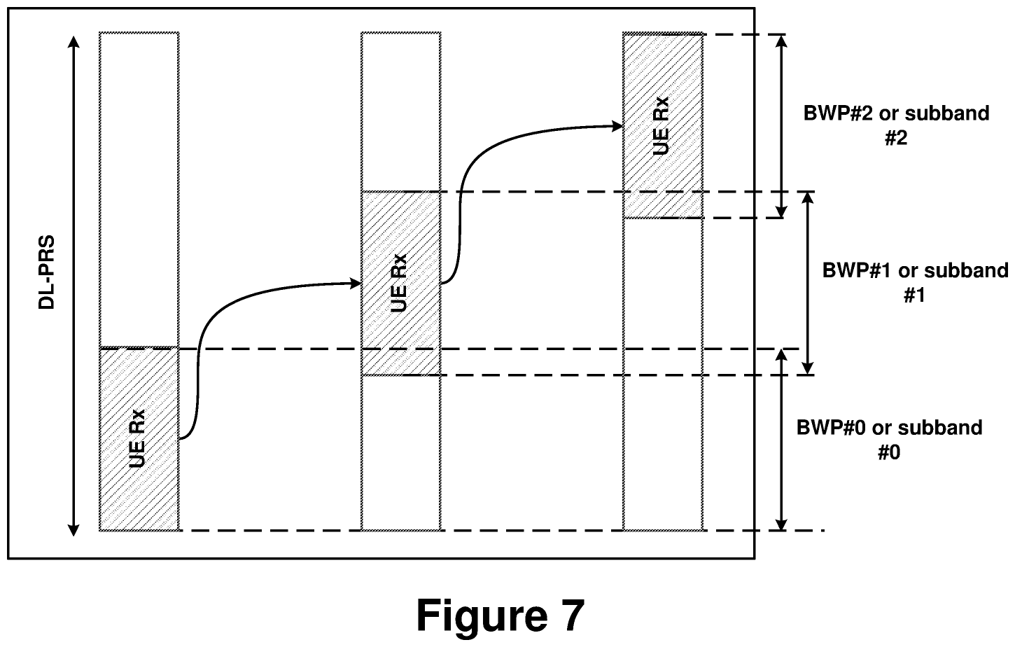

FIG. 7 illustrates one example of frequency hopping for reception of DL PRS for RedCap UEs. In the figure, DL PRS sequence is transmitted in the time frequency resource within a frequency subband or BWP based on frequency hopping pattern. In some aspects, gNB may transmit a single common DL PRS that can be received by both RedCap UEs and non-RedCap UEs, or gNB may only transmit DL PRS for RedCap UEs based on the frequency hopping pattern, while may not transmit the DL PRS in the remaining resources outside the frequency hopping pattern.

In some aspects, whether DL PRS sequence is mapped to the resource allocated for DL PRS transmission or the resource in accordance with the frequency hopping pattern may be configured by higher layers via RRC signalling.

In another embodiment, the starting PRB of the different hops may be configured by higher layers via RRC signalling. In addition, the reference point to indicate the starting PRB may be defined as Point A that corresponds to the lowest subcarrier of the common resource block (CRB) 0, or as starting PRB of DL PRS transmission in accordance with configuration of DL PRS positioning frequency layers, DL PRS resource set or DL PRS resource.

In another option, the reference point of the starting PRB may be defined as starting PRB of the configured BWP for RedCap UEs or the starting PRB of a subband defined above.

### Signalling Mechanisms for UL-SRS Transmission for Positioning for RedCap UEs

Embodiments of signalling mechanisms for UL-SRS transmission for positioning for RedCap UEs are described further below.

In one embodiment, an association between SRS resource set in a first UL BWP or subband and SRS resource set in a second UL BWP or subband may be configured by higher layers via RRC signalling. In this case, for periodic SRS transmission with frequency hopping, when the SRS resource set in the first UL BWP or subband is configured, SRS is also transmitted using the SRS resource set in the second UL BWP or subband in accordance with the association.

For semi-persistent SRS transmission with frequency hopping, when the SRS resource set in the first UL BWP or subband is activated or deactivated, SRS resource set in the second UL BWP or subband is also activated or deactivated in accordance with the association. For aperiodic SRS transmission with frequency hopping, when the SRS resource set in the first UL BWP or subband is triggered, SRS resource set in the second UL BWP or subband is also triggered in accordance with the association.

In an example of the embodiment, an association between SRS resource set in a first UL BWP or subband and SRS resource set in a second UL BWP or subband may be defined via a schedule for SRS transmissions on one or more SRS resource(s) within each SRS resource set based on a frequency resource hopping pattern defined as a function of time resources (symbols and/or slots).

In another option, the association between periodic/semi-persistent SRS resource set and BWPs or subbands could be updated by MAC-CE.

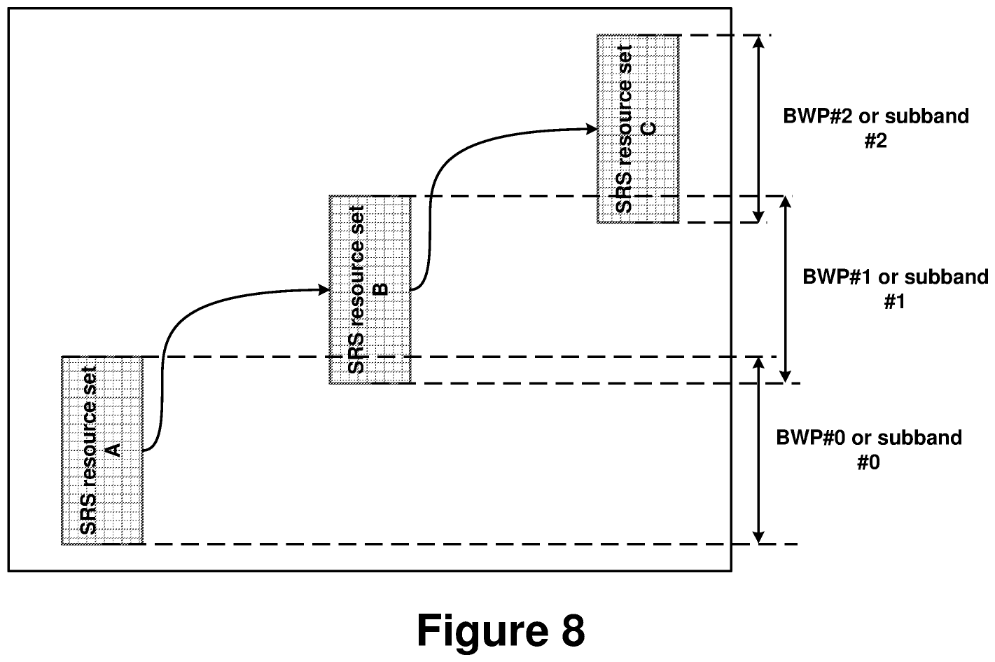

FIG. 8 illustrates one example of frequency hopping for SRS for positioning for RedCap UEs. In the figure, SRS resource set A in BWP #0 is associated with SRS resource set B in BWP #1 and SRS resource set C in BWP #2. When SRS resource set A in BWP #0 is activated or triggered, SRS resource set B in BWP #1 and SRS resource set C in BWP #2 are also activated or triggered, respectively.

In another embodiment, an association between SRS resource in a first UL BWP or subband and SRS resource in a second UL BWP or subband may be configured by higher layers via RRC signalling. In this case, for periodic SRS transmission with frequency hopping, when the SRS resource set including SRS resource in the first UL BWP or subband is configured, SRS is also transmitted using the SRS resource in the second BWP or subband in accordance with the association.

For semi-persistent SRS transmission with frequency hopping, when the SRS resource set including SRS resource in the first UL BWP or subband is activated or deactivated, SRS resource in the second UL BWP or subband is also activated or deactivated in accordance with the association. For aperiodic SRS transmission with frequency hopping, when the SRS resource set including SRS resource in the first UL BWP or subband is triggered, SRS resource in the second UL BWP or subband is also triggered in accordance with the association.

In an example of the embodiment, an association between SRS resource in a first UL BWP or subband and SRS resource in a second UL BWP or subband may be defined via configuration of a transmission schedule for SRS transmissions (e.g., an ordering/sequence of SRS transmissions) on the SRS resources based on a frequency resource hopping pattern defined as a function of time resources (symbols and/or slots).

In another embodiment, for semi-persistent SRS for positioning with frequency hopping for RedCap UEs, more than one SRS resources or resource sets in different UL BWPs or subbands in a carrier may be activated or deactivated via Medium Access Control—Control Element (MAC-CE). In addition, a new extended logical channel ID (eLCID) may be defined for semi-persistent SRS for positioning with frequency hopping for RedCap UE.

In one option, a set of UL BWPs or subbands in a carrier may be included in the activation/deactivation MAC-CE. Further, activated or deactivated SRS resource set in each BWP or subband may be included in the MAC-CE.

In another embodiment, for aperiodic SRS for positioning with frequency hopping for RedCap UEs, more than one SRS resource sets in different BWPs or subbands in a carrier may be triggered via DCI format 0_1, 0_2, 1_1, 1_2 and/or DCI format for multi-cell scheduling. In particular, joint SRS request field may indicate a row of a table for SRS request in more than one BWP in a carrier, which is configured by RRC signalling.

In one option, more than one set of UL BWPs or subbands in a carrier may be configured by higher layers via RRC signalling. One UL BWP or subband set could contain one BWP/subband or multiple BWPs/subbands, and one BWP/subband could belong to one BWP/subband set or several BWP sets. A code point of SRS request field in the DCI may be used to indicate one of the more than one set of associated UL BWPs or subbands are used for SRS transmission for positioning with frequency hopping for RedCap UEs.

In some aspects, to differentiate the SRS request for positioning with frequency hopping and the SRS request for other purpose, one bit field may be included the DCI format 0_1, 0_2, 1_1, 12, and/or the DCI format for multi-cell scheduling. In one example, bit “1” may be used to indicate that the SRS request is used for SRS for positioning with frequency hopping, while bit “0” may be used to indicate that the SRS request is not used to SRS for positioning with frequency hopping for RedCap UEs.

In another option, to differentiate the SRS request for positioning with frequency hopping and the SRS request for other purpose, some unused state or fields may be repurposed to indicate the SRS request for positioning with frequency hopping.

In another option, to differentiate the SRS request for positioning with frequency hopping and the SRS request for other purpose, a separate search space set may be configured for monitoring the DCI format which includes the SRS request for positioning with frequency hopping.

In another option, to differentiate the SRS request for positioning with frequency hopping and the SRS request for other purpose, a separate search space set may be configured for monitoring the DCI format which includes the SRS request for positioning with frequency hopping.

In another embodiment, a group common DCI may be defined to trigger SRS transmission for positioning with frequency hopping in different BWPs or subbands for RedCap UEs.

In one option, existing DCI format 2_3 may be extended to support the triggering of SRS transmission for positioning with frequency hopping in different BWPs or subbands. In this case, a new configuration field may be configured, e.g., Type C to indicate that the DCI format 2_3 is used to trigger SRS transmission for positioning with frequency hopping. In some aspects, the TPC command field(s) may be absent in the DCI format 23 with Type C configuration. In another option, the presence/absence of TPC command field(s) in DCI format 2_3 with Type C configuration could be configured via RRC signaling. Further, the aforementioned embodiments for triggering SRS transmission using SRS request via UE specific DCI format can be applied for group common DCI.

In another option, a new group common DCI format may be defined to support the triggering of SRS transmission for positioning with frequency hopping in different BWPs. In this case, a new Radio Network Temporary Identifier (RNTI) may be configured to UE to monitor the new group common DCI format. Further, the aforementioned embodiments for triggering SRS transmission using SRS request via UE specific DCI format can be applied for group common DCI.

In another embodiment, for SRS transmission for positioning with frequency hopping, the starting PRB of the different hops may be configured by higher layers via RRC signalling. In addition, the reference point of the starting PRB may be defined as Point A that corresponds to the lowest subcarrier of the common resource block (CRB) 0, or as starting PRB of SRS transmission in accordance with configuration of SRS resource set or SRS resource.

In another option, the reference point of the starting PRB may be defined as starting PRB of the configured UL BWP or subband for RedCap UEs or the starting PRB of the aforementioned subband.

Note that the concepts in the above embodiments and examples have been described for the case involving two SRS resource sets or SRS resources or UL BWPs or subbands (as applicable) within which frequency hopping is applied to simplify the exposition. It will be apparent that the disclosed techniques may be applied to cases involving more than two SRS resource sets or SRS resources or UL BWPs or subbands (as applicable) in accordance with various embodiments herein.

### Systems and Implementations

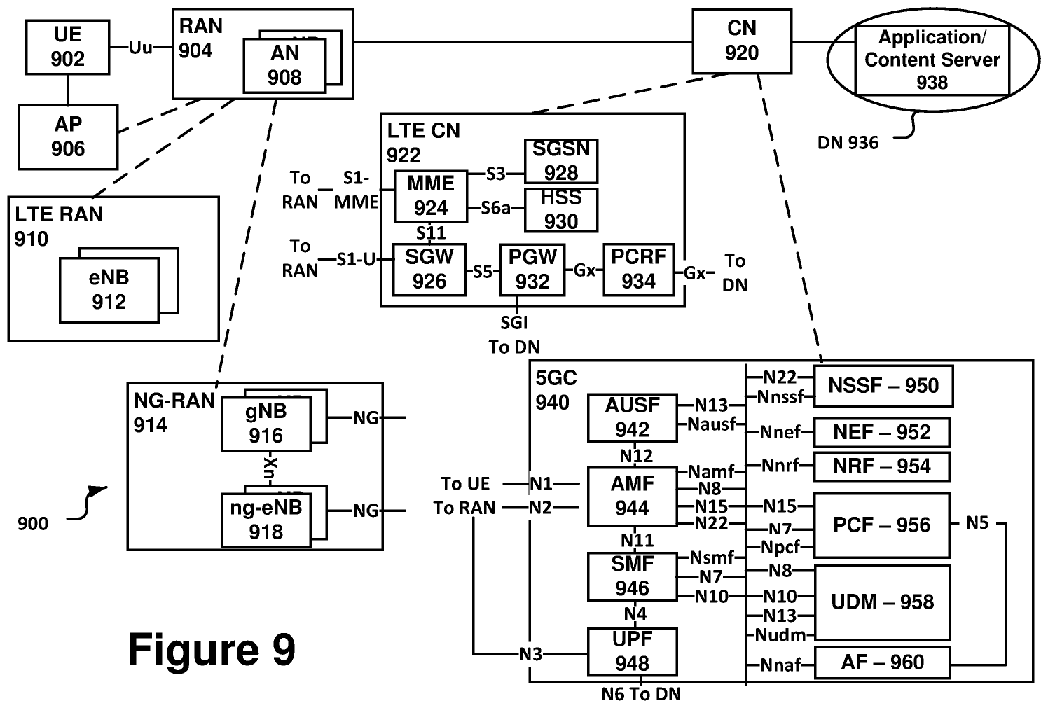

FIGS. 9-11 illustrate various systems, devices, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be communicatively coupled with the RAN 904 by a Uu interface. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-Fi®) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC, PDCP, RLC, MAC, and Li protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP, TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Peell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN914 and an AMF 944 (e.g., N2 interface).

The NG-RAN 914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924, SGW 926, SGSN 928, HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an S1 interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 9 36 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate QoS and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication-related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the SMF 946, and act as a transparent proxy for routing SM messages. AMF 944 may also provide transport for SMS messages between UE 902 and an SMSF. AMF 944 may interact with the AUSF 942 and the UE 902 to perform various security anchor and context management functions. Furthermore, AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure, AFs (e.g., AF 960), edge computing or fog computing systems, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR.

The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3^{rd} party services to be geographically close to a point that the UE 902 is attached to the network.

This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

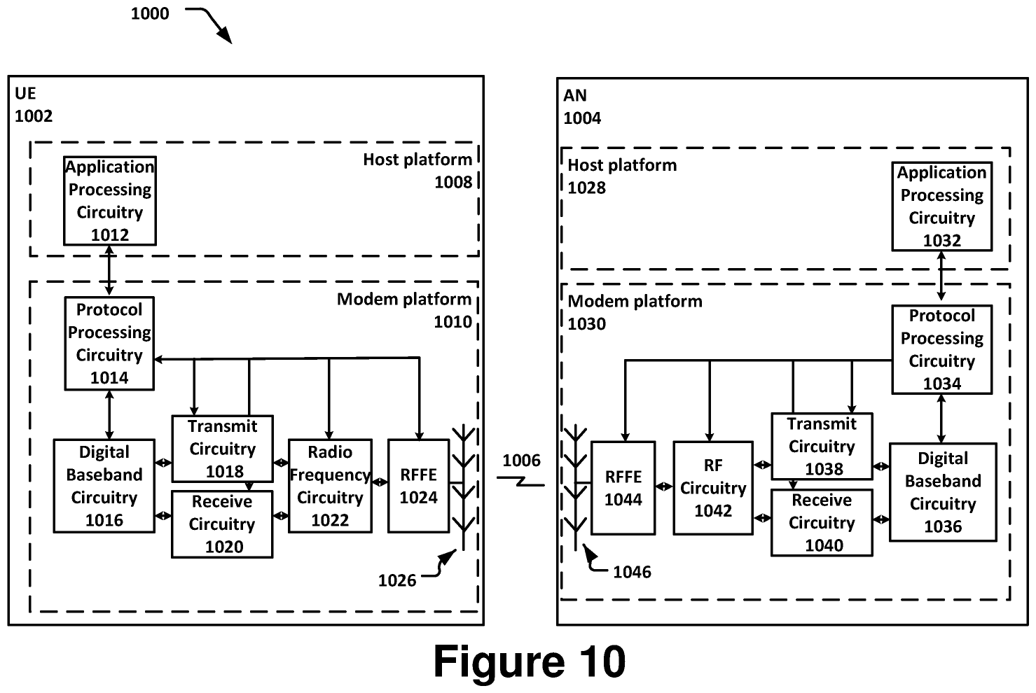

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHz frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

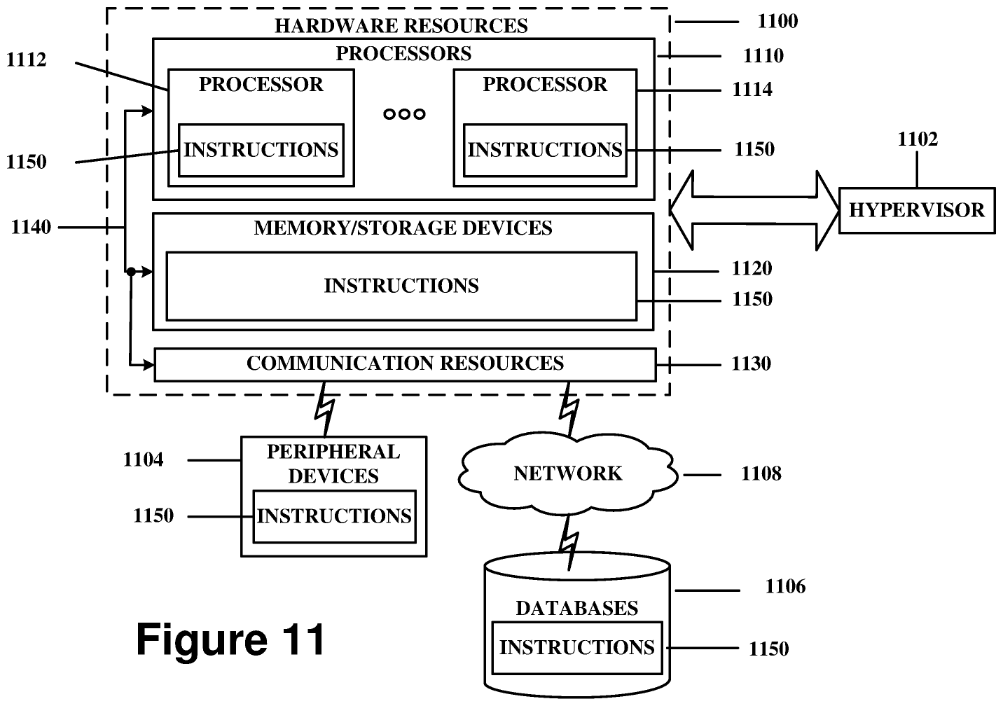

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

### EXAMPLE PROCEDURES

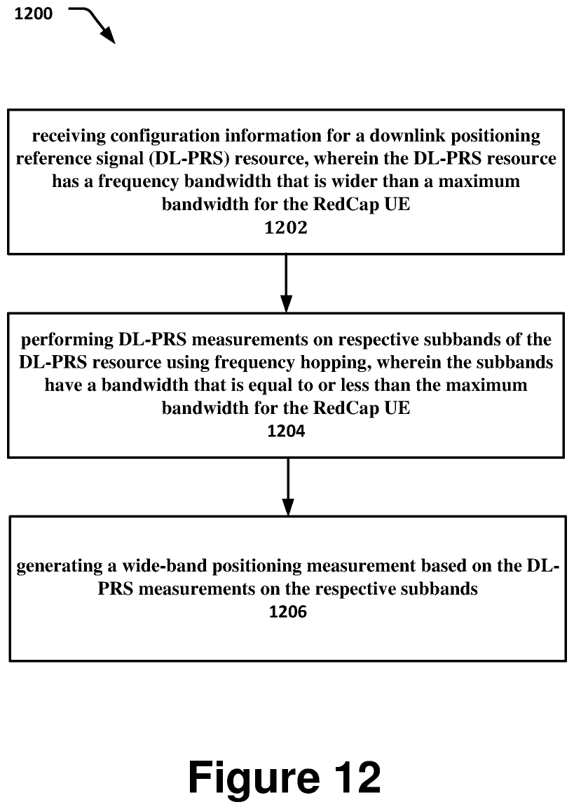

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof. One such process 1200 is depicted in FIG. 12. In some embodiments, the process 1200 may be performed by a UE, e.g., a RedCap UE, or a portion thereof. At 1202, the process 1200 may include receiving configuration information for a downlink positioning reference signal (DL-PRS) resource, wherein the DL-PRS resource has a frequency bandwidth that is wider than a maximum bandwidth for the RedCap UE. At 1204, the process 1200 may further include performing DL-PRS measurements on respective subbands of the DL-PRS resource using frequency hopping, wherein the subbands have a bandwidth that is equal to or less than the maximum bandwidth for the RedCap UE. At 1206, the process 1200 may further include generating a wide-band positioning measurement based on the DL-PRS measurements on the respective subbands.

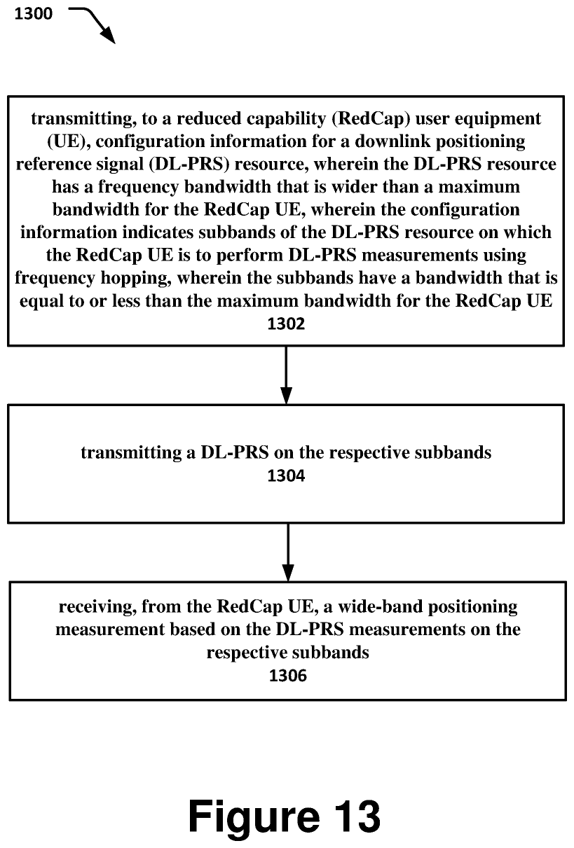

FIG. 13 illustrates another example process 1300 in accordance with various embodiments. In some embodiments, the process 1300 may be performed by a gNB or a portion thereof. At 1302, the process 1300 may include transmitting, to a reduced capability (RedCap) user equipment (UE), configuration information for a downlink positioning reference signal (DL-PRS) resource, wherein the DL-PRS resource has a frequency bandwidth that is wider than a maximum bandwidth for the RedCap UE, wherein the configuration information indicates subbands of the DL-PRS resource on which the RedCap UE is to perform DL-PRS measurements using frequency hopping, wherein the subbands have a bandwidth that is equal to or less than the maximum bandwidth for the RedCap UE. At 1304, the process 1300 may further include transmitting a DL-PRS on the respective subbands. At 1306, the process may further include receiving, from the RedCap UE, a wide-band positioning measurement based on the DL-PRS measurements on the respective subbands.

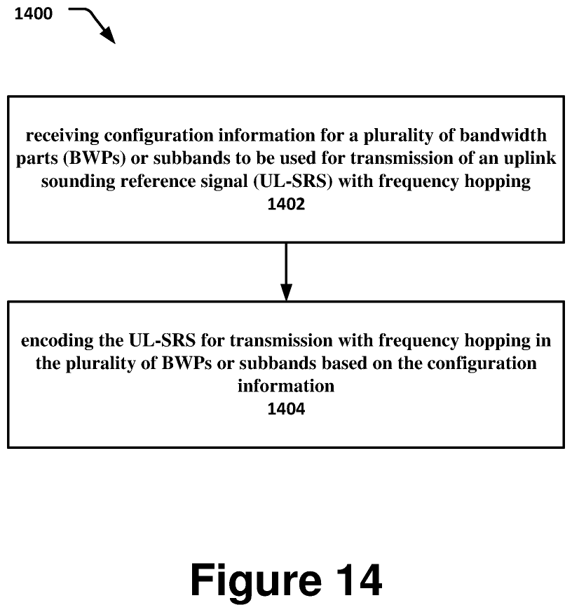

FIG. 14 illustrates another example process 1400 in accordance with various embodiments. The process 1400 may be performed by a UE (e.g., a RedCap UE) or a portion thereon. At 1402, the process 1400 may include receiving configuration information for a plurality of bandwidth parts (BWPs) or subbands to be used for transmission of an uplink sounding reference signal (UL-SRS) with frequency hopping. At 1404, the process 1400 may further include encoding the UL-SRS for transmission with frequency hopping in the plurality of BWPs or subbands based on the configuration information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example A1 may include an apparatus to be implemented in a reduced capability (RedCap) user equipment (UE), the apparatus comprising: a memory to store configuration information for a downlink positioning reference signal (DL-PRS) resource, wherein the DL-PRS resource has a frequency bandwidth that is wider than a maximum bandwidth for the RedCap UE; and processor circuitry to: perform DL-PRS measurements on respective subbands of the DL-PRS resource using frequency hopping, wherein the subbands have a bandwidth that is equal to or less than the maximum bandwidth for the RedCap UE; and generate a wide-band positioning measurement based on the DL-PRS measurements on the respective subbands.

Example A2 may include the apparatus of example A1 or some other example herein, wherein the measurements on the respective subbands are separated in a time domain by respective gaps.

Example A3 may include the apparatus of example A1-A2 or some other example herein, wherein two or more of the subbands partially overlap in a frequency domain.

Example A4 may include the apparatus of example A1-A3 or some other example herein, wherein the processor circuitry is to receive the configuration information via radio resource control (RRC) signaling.

Example A5 may include the apparatus of example A1-A4 or some other example herein, wherein the configuration information indicates a frequency hopping pattern for the DL-PRS measurements.

Example A6 may include the apparatus of example A5 or some other example herein, wherein the configuration information further indicates a starting physical resource block (PRB) of the different frequency hops.

Example A7 may include the apparatus of example A6 or some other example herein, wherein the processor circuitry is further to identify a reference point to indicate the starting PRB, wherein the reference point corresponds to: a lowest subcarrier of a common resource block (CRB) 0; a starting PRB of a DL-PRS transmission in accordance with a configuration of DL-PRS positioning frequency layers, a DL-PRS resource set, or a DL-PRS resource; or a starting PRB of a configured bandwidth part (BWP) or a subband of the RedCap UE.

Example A8 may include the apparatus of any one of examples A1-A7 or some other example herein, wherein the processor circuitry is to report the wideband positioning measurement to a next generation Node B (gNB).

Example A9 may include an apparatus to be implemented in a reduced capability (RedCap) user equipment (UE), the apparatus comprising: a memory to store configuration information for a plurality of bandwidth parts (BWPs) or subbands to be used for transmission of an uplink sounding reference signal (UL-SRS) with frequency hopping; and processor circuitry to encode the UL-SRS for transmission with frequency hopping in the plurality of BWPs or subbands based on the configuration information.

Example A10 may include the apparatus of example A9 or some other example herein, wherein the UL-SRS is transmitted with a gap between respective frequency hops.

Example All may include the apparatus of example A10 or some other example herein, wherein the gap is defined as a number of symbols or slots.

Example A12 may include the apparatus of example All or some other example herein, wherein the number of symbols or slots is based on a numerology of the UL-SRS.

Example A13 may include the apparatus of example A9-A12 or some other example herein, wherein individual BWPs or subbands have a bandwidth that is less than or equal to a maximum bandwidth for the RedCap UE, and wherein the plurality of BWPs or subbands together have a bandwidth that is greater than the maximum bandwidth.

Example A14 may include the apparatus of example A9-A13 or some other example herein, wherein the configuration information indicates an association between a first SRS resource or resource set in a first BWP or subband of the BWPs or subbands and a second SRS resource or resource set in a second BWP or subband of the BWPs or subbands.

Example A15 may include the apparatus of example A14 or some other example herein, wherein the processor circuitry is further to: receive an indication that the first SRS resource or resource set is activated or deactivated; and determine that the second SRS resource set or resource is activated or deactivated based on the association.

Example A16 may include the apparatus of any one of examples A9-A15 or some other example herein, wherein the SRS is a semi-persistent SRS.

Example A17 may include one or more non-transitory computer-readable media (NTCRM) having instructions, stored thereon, that when executed by one or more processors of a next generation Node B (gNB), configure the gNB to: transmit, to a reduced capability (RedCap) user equipment (UE), configuration information for a downlink positioning reference signal (DL-PRS) resource, wherein the DL-PRS resource has a frequency bandwidth that is wider than a maximum bandwidth for the RedCap UE, wherein the configuration information indicates subbands of the DL-PRS resource on which the RedCap UE is to perform DL-PRS measurements using frequency hopping, wherein the subbands have a bandwidth that is equal to or less than the maximum bandwidth for the RedCap UE; transmit a DL-PRS on the respective subbands; and receive, from the RedCap UE, a wide-band positioning measurement based on the DL-PRS measurements on the respective subbands.

Example A18 may include the one or more NTCRM of example A17 or some other example herein, wherein the DL-PRS transmissions on the respective subbands are separated in a time domain by respective gaps.

Example A19 may include the one or more NTCRM of example A17-A18 or some other example herein, wherein two or more of the subbands partially overlap in a frequency domain.

Example A20 may include the one or more NTCRM of any one of examples A17-A19 or some other example herein, wherein the configuration information indicates a frequency hopping pattern for the DL-PRS measurements.

Example B1 may include a method of wireless communication in a wireless cellular network, the method comprising: Configuring, by a gNB, one or more downlink (DL) bandwidth part (BWP) or subbands for a DL positioning reference signal (DL-PRS) or sounding reference signal (SRS) for positioning with frequency hopping; and Configuring, by the gNB, one or more gaps between DL-PRS and SRS for positioning with frequency hopping.

Example B2 may include the method of example B1 or some other example herein, wherein DL PRS sequence is generated in accordance with the DL PRS positioning frequency layer configuration that may exceed the maximum supported bandwidth by a RedCap UE; wherein DL PRS sequence may be mapped to the time-frequency resources allocated for DL PRS transmission in accordance with DL PRS positioning frequency layer configuration.

Example B3 may include the method of example B1 or some other example herein, wherein a RedCap UE may assume that a DL PRS sequence is transmitted in the time-frequency resources confined to a frequency subband in accordance with a frequency hopping pattern provided to a RedCap UE.

Example B4 may include the method of example B1 or some other example herein, wherein the starting PRB of the different hops may be configured by higher layers via RRC signalling.

Example B5 may include the method of example B1 or some other example herein, wherein the reference point to indicate the starting PRB may be defined as Point A that corresponds to the lowest subcarrier of the common resource block (CRB) 0, or as starting PRB of DL PRS transmission in accordance with configuration of DL PRS positioning frequency layers, DL PRS resource set or DL PRS resource.

Example B6 may include the method of example B1 or some other example herein, wherein the reference point of the starting PRB may be defined as starting PRB of the configured BWP for RedCap UEs or the starting PRB of a subband.

Example B7 may include the method of example B1 or some other example herein, wherein an association between SRS resource set in a first UL BWP and SRS resource set in a second UL BWP may be configured by higher layers via RRC signalling.

Example B8 may include the method of example B1 or some other example herein, wherein for semi-persistent SRS transmission with frequency hopping, when the SRS resource set in the first UL BWP is activated or deactivated, SRS resource set in the second UL BWP is also activated or deactivated in accordance with the association.

Example B9 may include the method of example B1 or some other example herein, wherein for aperiodic SRS transmission with frequency hopping, when the SRS resource set in the first UL BWP is triggered, SRS resource set in the second UL BWP is also triggered in accordance with the association.

Example B10 may include the method of example B1 or some other example herein, wherein an association between SRS resource in a first UL BWP and SRS resource in a second UL BWP may be configured by higher layers via RRC signalling.

Example B11 may include the method of example B1 or some other example herein, wherein for semi-persistent SRS for positioning with frequency hopping for RedCap UEs, more than one SRS resource sets in different UL BWPs in a carrier may be activated or deactivated via Medium Access Control—Control Element (MAC-CE).

Example B12 may include the method of example B1 or some other example herein, wherein for aperiodic SRS for positioning with frequency hopping for RedCap UEs, more than one SRS resource sets in different BWPs in a carrier may be triggered via DCI format 0_1, 0_2, 1_1, 1_2 and/or DCI format for multi-cell scheduling.

Example B13 may include the method of example B1 or some other example herein, wherein a group common DCI may be defined to trigger SRS transmission for positioning with frequency hopping in different BWPs for RedCap UEs.

Example B14 may include the method of example B1 or some other example herein, wherein for SRS transmission for positioning with frequency hopping, the starting PRB of the different hops may be configured by higher layers via RRC signalling.

Example B15 may include the method of example B1 or some other example herein, wherein the reference point of the starting PRB may be defined as Point A that corresponds to the lowest subcarrier of the common resource block (CRB) 0, or as starting PRB of SRS transmission in accordance with configuration of SRS resource set or SRS resource.

Example B16 may include the method of example B1 or some other example herein, wherein the reference point of the starting PRB may be defined as starting PRB of the configured UL BWP for RedCap UEs or the starting PRB of the aforementioned subband.

Example B17 may include a method of a reduced capability (RedCap) user equipment (UE), the method comprising:
receiving configuration information to indicate one or more downlink (DL) bandwidth parts (BWPs) or subbands for a DL positioning reference signal (DL PRS) or a sounding reference signal (SRS) for positioning with frequency hopping, wherein the configuration information further includes one or more gaps between frequency hops of the DL PRS or SRS; and
receiving the DL-PRS or transmitting the SRS based on the configuration information.

Example B18 may include the method of example B17 or some other example herein, wherein a DL PRS sequence for the DL PRS is generated in accordance with a DL PRS positioning frequency layer configuration, and wherein the DL PRS sequence is mapped to time-frequency resources allocated for DL PRS transmission in accordance with a DL PRS positioning frequency layer configuration.

Example B19 may include the method of example B18 or some other example herein, wherein the DL PRS positioning frequency layer configuration exceeds a maximum supported bandwidth by a RedCap UE.

Example B20 may include the method of example B17-19 or some other example herein, wherein the configuration information indicates a frequency hopping pattern for the DL PRS, and wherein the DL PRS is received based on an assumption that a DL PRS sequence is transmitted in time-frequency resources confined to a frequency subband in accordance with the frequency hopping pattern.

Example B21 may include the method of example B17-20 or some other example herein, wherein the configuration information further indicates a starting PRB of the different frequency hops.

Example B22 may include the method of example B17-21 or some other example herein, further comprising identifying a reference point to indicate a starting PRB of the DL PRS, wherein the reference point corresponds to a lowest subcarrier of a common resource block (CRB) 0, or as a starting PRB of the DL PRS transmission in accordance with a configuration of DL PRS positioning frequency layers, a DL PRS resource set, or a DL PRS resource.

Example B23 may include the method of example B17-22 or some other example herein, further comprising identifying a reference point to indicate a starting PRB of the DL PRS, wherein the reference point is defined as a starting PRB of a configured BWP for RedCap UEs or a starting PRB of a subband Example B24 may include the method of example B17-23 or some other example herein, wherein the configuration information for the SRS indicates an association between a first SRS resource set in a first UL BWP and a second SRS resource set in a second UL BWP.

Example B25 may include the method of example B24 or some other example herein, further comprising receiving an indication that the first SRS resource set is activated or deactivated, and determining that the second SRS resource set is activated or deactivated based on the association.

Example B26 may include the method of example B17-26 or some other example herein, wherein the SRS is a semi-persistent SRS.

Example B27 may include the method of example B17-26 or some other example herein, further comprising receiving a medium access control—control element (MAC-CE) to activate multiple SRS resource sets in different UL BWPs in a carrier for the SRS.

Example B28 may include the method of example B24 or some other example herein, wherein the SRS is an aperiodic SRS, and wherein the method further comprises receiving an indication that the first SRS resource set is triggered, and determining that the second SRS resource set is also triggered based on the association.

Example B29 may include the method of example B17-23, 28, or some other example herein, further comprising receiving a downlink control information (DCI) to trigger multiple SRS resource sets in different UL BWPs in a carrier.

Example B30 may include the method of example B29 or some other example herein, wherein the DCI has a DCI format 0_1, 0_2, 1_1, 1_2 and/or DCI format for multi-cell scheduling.

Example B31 may include the method of example B17-30 or some other example herein, further comprising receiving a group common DCI to trigger the SRS transmission in different BWPs.

Example B32 may include the method of example B17-32 or some other example herein, wherein the configuration information indicates a starting PRB of the different frequency hops of the SRS.

Example B33 may include the method of example B17-32 or some other example herein, further comprising identifying a reference point to indicate a starting PRB of the SRS, wherein the reference point corresponds to a lowest subcarrier of a common resource block (CRB) 0, or as a starting PRB of SRS transmission in accordance with a configuration of a SRS resource set or a SRS resource.

Example B34 may include the method of example B17-32 or some other example herein, further comprising identifying a reference point to indicate a starting PRB of the SRS, wherein the reference point is defined as a starting PRB of a configured UL BWP for RedCap UEs or a starting PRB of the respective subband.

Example B35 may include a method of a next generation Node B (gNB), the method comprising:
encoding, for transmission to a reduced capability (RedCap) user equipment (UE), configuration information to indicate one or more downlink (DL) bandwidth parts (BWPs) or subbands for a DL positioning reference signal (DL PRS) or a sounding reference signal (SRS) for positioning with frequency hopping, wherein the configuration information further includes one or more gaps between frequency hops of the DL PRS or SRS; and
transmitting the DL-PRS or receiving the SRS based on the configuration information.

Example B36 may include the method of example B35 or some other example herein, further comprising generating a DL PRS sequence in accordance with a DL PRS positioning frequency layer configuration, and wherein the DL PRS sequence is mapped to time-frequency resources allocated for DL PRS transmission in accordance with a DL PRS positioning frequency layer configuration.

Example B37 may include the method of example B36 or some other example herein, wherein the DL PRS positioning frequency layer configuration exceeds a maximum supported bandwidth by the RedCap UE.

Example B38 may include the method of example B35-37 or some other example herein, wherein the configuration information indicates a frequency hopping pattern for the DL PRS, and wherein the UE is to receive the DL PRS based on an assumption that a DL PRS sequence is transmitted in time-frequency resources confined to a frequency subband in accordance with the frequency hopping pattern.

Example B39 may include the method of example B35-38 or some other example herein, wherein the configuration information further indicates a starting PRB of the different frequency hops.

Example B40 may include the method of example B35-39 or some other example herein, wherein a reference point to indicate a starting PRB of the DL PRS corresponds to a lowest subcarrier of a common resource block (CRB) 0, or as a starting PRB of the DL PRS transmission in accordance with a configuration of DL PRS positioning frequency layers, a DL PRS resource set, or a DL PRS resource.

Example B41 may include the method of example B35-40 or some other example herein, wherein a reference point to indicate a starting PRB of the DL PRS is defined as a starting PRB of a configured BWP for RedCap UEs or a starting PRB of a subband Example B42 may include the method of example B35-41 or some other example herein, wherein the configuration information for the SRS indicates an association between a first SRS resource set in a first UL BWP and a second SRS resource set in a second UL BWP.

Example B43 may include the method of example B42 or some other example herein, further comprising transmitting an indication that the first SRS resource set is activated or deactivated, wherein the indication also activates or deactivates the second SRS resource set based on the association.

Example B44 may include the method of example B35-43 or some other example herein, wherein the SRS is a semi-persistent SRS.

Example B45 may include the method of example B35-44 or some other example herein, further comprising transmitting, to the UE, a medium access control—control element (MAC-CE) to activate multiple SRS resource sets in different UL BWPs in a carrier for the SRS.

Example B46 may include the method of example B42 or some other example herein, wherein the SRS is an aperiodic SRS, and wherein the method further comprises transmitting, to the UE, an indication that the first SRS resource set is triggered, wherein the indication also triggers the second SRS resource set based on the association.

Example B47 may include the method of example B35-46 or some other example herein, further comprising transmitting, to the UE, a downlink control information (DCI) to trigger multiple SRS resource sets in different UL BWPs in a carrier.

Example B48 may include the method of example B47 or some other example herein, wherein the DCI has a DCI format 0_1, 0_2, 1_1, 1_2 and/or DCI format for multi-cell scheduling.

Example B49 may include the method of example B35-48 or some other example herein, further comprising transmitting, to a plurality of UEs including the UE, a group common DCI to trigger the SRS transmission in different BWPs.

Example B50 may include the method of example B35-49 or some other example herein, wherein the configuration information indicates a starting PRB of the different frequency hops of the SRS.

Example B51 may include the method of example B35-50 or some other example herein, further comprising identifying a reference point to indicate a starting PRB of the SRS, wherein the reference point corresponds to a lowest subcarrier of a common resource block (CRB) 0, or as a starting PRB of SRS transmission in accordance with a configuration of a SRS resource set or a SRS resource.

Example B52 may include the method of example B35-51 or some other example herein, further comprising identifying a reference point to indicate a starting PRB of the SRS, wherein the reference point is defined as a starting PRB of a configured UL BWP for RedCap UEs or a starting PRB of the respective subband.

Example C1 may include a method of wireless communication for a fifth generation (5G) or new radio (NR) system, the method comprising:
Configuring, by a gNB, one or more downlink (DL) bandwidth part (BWP) for a DL positioning reference signal (DL-PRS) repetitions; and
Configuring, by the gNB, one or more gaps between DL-PRS repetitions.

Example C2 may include the method of example C1 or some other example herein, wherein wideband DL-PRS transmission may be configured to a RedCap UE for a DL-PRS resource such that the wideband DL-PRS transmission BW may exceed the maximum RedCap UE BW for the corresponding Frequency Range (FR).

Example C3 may include the method of example C1 or some other example herein, wherein multiple subbands for DL-PRS transmission in frequency can be configured by higher layers via radio resource control (RRC) signalling.

Example C4 may include the method of example C1 or some other example herein, wherein subband size and subband distance between two adjacent subbands in each DL-PRS repetition can be configured by higher layers via RRC signalling.

Example C5 may include the method of example C1 or some other example herein, wherein the subband size and number of overlapping PRBs between two subbands can be configured by higher layers via RRC signalling.

Example C6 may include the method of example C1 or some other example herein, wherein the starting subband index for the frequency hopping can be configured by higher layers via RRC signalling; wherein the subband index can be increased by 1 and modulo on total number of subbands for the subsequent DL-PRS repetition in a DL-PRS resource.

Example C7 may include the method of example C1 or some other example herein, wherein a DL-PRS frequency hopping pattern may be defined in accordance with one or more following parameters: starting PRB for the first repetition, the subband index and DL-PRS repetition index.

Example C8 may include the method of example C1 or some other example herein, wherein UE performs subband frequency hopping for positioning measurement on a group of every K DL-PRS repetitions; wherein within the group of every K DL-PRS repetitions, same set of PRBs are used for DL-PRS measurement.

Example C9 may include the method of example C8 or some other example herein, wherein two gaps between DL-PRS repetitions may be configured by higher layers, where the first gap may be configured between two repetitions within a group of every K DL-PRS repetitions; and the second gap may be configured between two groups of every K DL-PRS repetitions.

Example C10 may include the method of example C1 or some other example herein, wherein DL-PRS repetitions for a DL-PRS resource may be transmitted in different DL bandwidth parts (BWPs) that may be configured to a RedCap UE for frequency hopping.

Example C11 may include the method of example C1 or some other example herein, wherein a gap may be configured between two DL-PRS repetitions for BWP switching; wherein the gaps may be defined in accordance with a number of symbols or slots or absolute time.

Example C12 may include the method of example C1 or some other example herein, wherein a group of every K DL-PRS repetitions for a DL-PRS resource may be transmitted in different DL BWPs configured to a RedCap UE for frequency hopping.

Example C13 may include the method of example C12 or some other example herein, wherein two gaps between DL-PRS repetitions may be configured by higher layers, where the first gap may be configured between two repetitions within a group of every K DL-PRS repetitions; and the second gap may be configured between two groups of every K DL-PRS repetitions.

Example C14 may include the method of example C1 or some other example herein, wherein a RedCap UE may be configured with a DL-PRS configuration such that the DL-PRS are mapped to one of N subbands or N DL BWPs across r*N consecutive DL-PRS transmission occasions such that a pair of consecutive DL-PRS occasions may be separated by a time gap of a number of symbols or slots of absolute time, wherein r is an integer greater than or equal to one.

Example C15 may include the method of example C1 or some other example herein, wherein UL SRS repetitions for positioning for a UL SRS resource are transmitted in different UL BWPs configured to a RedCap UE for frequency hopping.

Example C16 may include the method of example C15 or some other example herein, wherein a gap may be configured between two UL SRS repetitions for BWP switching; wherein the gaps may be defined in accordance with a number of symbols or slots or absolute time.

Example C17 may include the method of example C1 or some other example herein, wherein a group of every K SRS repetitions for positioning for a SRS resource are transmitted in different UL BWP for frequency hopping; wherein same set of frequency resources are used for SRS repetitions within the group of every K SRS repetitions.

Example C18 may include the method of example C17 or some other example herein, wherein two gaps between SRS repetitions may be configured by higher layers, where the first gap may be configured between two repetitions within a group of every K SRS repetitions; and the second gap may be configured between two groups of every K SRS repetitions.

Example C19 may include the method of example C1 or some other example herein, wherein a RedCap UE may be configured with a SRS configuration such that the SRS are mapped to one of N UL BWPs across r*N consecutive SRS transmission occasions such that a pair of consecutive SRS occasions may be separated by a time gap of a number of symbols or slots of absolute time, wherein r is an integer greater than or equal to one.

Example C20 may include a method of a reduced capability (RedCap) user equipment (UE), the method comprising:
receiving configuration information for a downlink positioning reference signal (DL-PRS) resource, wherein the DL-PRS resource has a frequency bandwidth that is wider than a maximum bandwidth for the RedCap UE; and
performing one or more DL-PRS measurements on respective subbands of the DL-PRS resource using frequency hopping, wherein the subbands have a bandwidth that is equal to or less than the maximum bandwidth for the RedCap UE.

Example C21 may include the method of example C20 or some other example herein, wherein the configuration information is to configure the subbands.

Example C22 may include the method of example C20-21 or some other example herein, wherein the measurements on the individual subbands are separated in the time domain by one or more respective gaps.

Example C23 may include the method of example C20-22 or some other example herein, wherein the configuration information is further to configure the one or more gaps.

Example C24 may include the method of example C20-23 or some other example herein, further comprising stitching the measurements for the multiple subbands together to generate a wideband measurement.

Example C25 may include the method of example C24 or some other example herein, further comprising reporting the wideband measurement to a gNB.

Example Z01 may include an apparatus comprising means to perform one or more elements of a method described in or related to any of examples A1-A20, B1-B52, C1-C25, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A20, B1-B52, C1-C25, or any other method or process described herein.

Example Z03 may include an apparatus comprising logic, modules, or circuitry to perform one or more elements of a method described in or related to any of examples A1-A20, B1-B52, C1-C25, or any other method or process described herein.

Example Z04 may include a method, technique, or process as described in or related to any of examples A1-A20, B1-B52, C1-C25, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A20, B1-B52, C1-C25, or portions thereof.

Example Z06 may include a signal as described in or related to any of examples A1-A20, B1-B52, C1-C25, or portions or parts thereof.

Example Z07 may include a datagram, packet, frame, segment, protocol data unit (PDU), or message as described in or related to any of examples A1-A20, B1-B52, C1-C25, or portions or parts thereof, or otherwise described in the present disclosure.

Example Z08 may include a signal encoded with data as described in or related to any of examples A1-A20, B1-B52, C1-C25, or portions or parts thereof, or otherwise described in the present disclosure.

Example Z09 may include a signal encoded with a datagram, packet, frame, segment, protocol data unit (PDU), or message as described in or related to any of examples A1-A20, B1-B52, C1-C25, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A20, B1-B52, C1-C25, or portions thereof.

Example Z11 may include a computer program comprising instructions, wherein execution of the program by a processing element is to cause the processing element to carry out the method, techniques, or process as described in or related to any of examples A1-A20, B1-B52, C1-C25, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| ADRF | Analytics Data Repository Function |
| AF | Application Function |
| AM | Acknowledged Mode |
| AMBR | Aggregate Maximum Bit Rate |
| AMF | Access and Mobility Management Function |
| AN | Access Network |
| AnLF | Analytics Logical Function |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBD | Candidate Beam Detection |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS |
| | Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE |
| | Radio Access Network |
| GGSN | Gateway GPRS Support Node |
| GLONASS | GLObal'naya NAvigatsionnaya Sputnikovaya |
| | Sistema (Engl.: Global Navigation Satellite |
| | System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, Groupe |
| | Spécial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-IMAC | used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information |
| | Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTCmassive | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manage |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWDAF | Network Data Analytics Function |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSFCH | physical sidelink feedback channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block SSBRI SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.” The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. An apparatus to be implemented in a reduced capability (RedCap) user equipment (UE), the apparatus comprising:
a memory to store configuration information for a downlink positioning reference signal (DL-PRS) resource, wherein the DL-PRS resource has a frequency bandwidth that is wider than a maximum bandwidth for the RedCap UE; and
processor circuitry to:
perform DL-PRS measurements on respective subbands of the DL-PRS resource using frequency hopping, wherein the subbands have a bandwidth that is equal to or less than the maximum bandwidth for the RedCap UE; and
generate a wide-band positioning measurement based on the DL-PRS measurements on the respective subbands.

22. The apparatus of claim 21, wherein the measurements on the respective subbands are separated in a time domain by respective gaps.

23. The apparatus of claim 21, wherein two or more of the subbands partially overlap in a frequency domain.

24. The apparatus of claim 21, wherein the processor circuitry is to receive the configuration information via radio resource control (RRC) signaling.

25. The apparatus of claim 21, wherein the configuration information indicates a frequency hopping pattern for the DL-PRS measurements.

26. The apparatus of claim 25, wherein the configuration information further indicates a starting physical resource block (PRB) of the different frequency hops.

27. The apparatus of claim 26, wherein the processor circuitry is further to identify a reference point to indicate the starting PRB, wherein the reference point corresponds to:
a lowest subcarrier of a common resource block (CRB) 0;
a starting PRB of a DL-PRS transmission in accordance with a configuration of DL-PRS positioning frequency layers, a DL-PRS resource set, or a DL-PRS resource; or
a starting PRB of a configured bandwidth part (BWP) or a subband of the RedCap UE.

28. The apparatus of claim 21, wherein the processor circuitry is to report the wideband positioning measurement to a next generation Node B (gNB).

29. An apparatus to be implemented in a reduced capability (RedCap) user equipment (UE), the apparatus comprising:
a memory to store configuration information for a plurality of bandwidth parts (BWPs) or subbands to be used for transmission of an uplink sounding reference signal (UL-SRS) with frequency hopping; and
processor circuitry to encode the UL-SRS for transmission with frequency hopping in the plurality of BWPs or subbands based on the configuration information.

30. The apparatus of claim 29, wherein the UL-SRS is transmitted with a gap between respective frequency hops.

31. The apparatus of claim 30, wherein the gap is defined as a number of symbols or slots.

32. The apparatus of claim 31, wherein the number of symbols or slots is based on a numerology of the UL-SRS.

33. The apparatus of claim 29, wherein individual BWPs or subbands have a bandwidth that is less than or equal to a maximum bandwidth for the RedCap UE, and wherein the plurality of BWPs or subbands together have a bandwidth that is greater than the maximum bandwidth.

34. The apparatus of claim 29, wherein the configuration information indicates an association between a first SRS resource or resource set in a first BWP or subband of the BWPs or subbands and a second SRS resource or resource set in a second BWP or subband of the BWPs or subbands.

35. The apparatus of claim 34, wherein the processor circuitry is further to:
receive an indication that the first SRS resource or resource set is activated or deactivated; and
determine that the second SRS resource set or resource is activated or deactivated based on the association.

36. The apparatus of claim 29, wherein the SRS is a semi-persistent SRS.

37. One or more non-transitory computer-readable media (NTCRM) having instructions, stored thereon, that when executed by one or more processors of a next generation Node B (gNB), configure the gNB to:
transmit, to a reduced capability (RedCap) user equipment (UE), configuration information for a downlink positioning reference signal (DL-PRS) resource, wherein the DL-PRS resource has a frequency bandwidth that is wider than a maximum bandwidth for the RedCap UE, wherein the configuration information indicates subbands of the DL-PRS resource on which the RedCap UE is to perform DL-PRS measurements using frequency hopping, wherein the subbands have a bandwidth that is equal to or less than the maximum bandwidth for the RedCap UE;
transmit a DL-PRS on the respective subbands; and
identify, received from the RedCap UE, a wide-band positioning measurement based on the DL-PRS measurements on the respective subbands.

38. The one or more NTCRM of claim 37, wherein the DL-PRS transmissions on the respective subbands are separated in a time domain by respective gaps.

39. The one or more NTCRM of claim 37, wherein two or more of the subbands partially overlap in a frequency domain.

40. The one or more NTCRM of claim 37, wherein the configuration information indicates a frequency hopping pattern for the DL-PRS measurements.
